(19) United States
(12) Patent Application Publication
(10) Pub. No.: US 2016/0265830 A1
(43) Pub. Date: Sep. 15, 2016

(54) Method and Apparatus for Monitoring and Controlling Absorption Cooling Units

(71) Applicant: Wick G. Weckwerth, Heber Springs, AR (US)

(72) Inventor: Wick G. Weckwerth, Heber Springs, AR (US)

(21) Appl. No.: 15/066,306

(22) Filed: Mar. 10, 2016

Related U.S. Application Data
(60) Provisional application No. 62/131,439, filed on Mar. 11, 2015.

(51) Int. Cl. F25B 49/04; B60H 1/32; F25B 15/00

(52) U.S. Cl. CPC F25B 49/043; F25B 15/00; B60H 1/3201

(57) ABSTRACT

An absorption cooler and a controller. The cooler comprises a mixture of ammonia, water and hydrogen gas. A boiler section drives refrigeration, a rectifier section separates and distills ammonia vapor and steam, and a condenser assembly liquefies ammonia vapor. Cooling occurs from an evaporator. A bypass tube connects the condenser with an absorber vessel. A first sensor in contact with the rectifier section establishes a first sensing zone for monitoring temperature to determine unlevel operation. A second sensing zone monitors condenser temperature and a third sensing zone monitors bypass tube temperature. The controller is responsive to the sensors and activates or deactivates the cooler or components in response. When unsafe vapor temperature at the exit of the condenser is sensed, auxiliary fans increase airflow, but if vapor temperature fails to drop, the refrigeration cycle is no longer continuous and power is interrupted.

### CROSS REFERENCE TO RELATED APPLICATION

This utility conversion application is based upon, and claims priority from, a previously filed, pending U.S. application entitled “Method and Apparatus for Monitoring and Controlling Absorption Cooling Units”, Ser. No. 62/131,439, Filed Mar. 11, 2015 by inventor Wick G. Weckwerth.

### BACKGROUND OF THE INVENTION

I. Field of the Invention

The present invention relates generally to continuous cycle absorption refrigeration units of the type commonly used in recreational vehicles and campers. More particularly, the present invention relates to such coolers fitted with apparatus for monitoring temperatures in selected, critical operating areas, and for controlling the refrigeration apparatus in response. Known prior art includes cooling apparatus of the type classified in United States Patent Class 62, Subclasses 476 and 479, and includes controlling apparatus for such units of the type classified in U. S. Patent Class 62, subclasses 132 and 141.

II. Description of the Prior Art

Many campers and recreational vehicles (i.e., RV's) use a refrigerator with an absorption type cooling or refrigeration unit. Such popular continuous cycle RV absorption cooling units use a mixture of ammonia/water and hydrogen as a refrigerant mixture, and sodium chromate as a rust inhibitor. Characteristically they operate at a single pressure. A heat source such as an electric resistance heating element or a propane burner heats a boiler tube to start the refrigeration process, and the operator thus has a choice of energy sources. The ability to operate the absorption cooling unit with a propane burner is desirable in recreational vehicles because it facilitates operation of the refrigerator unit in remote areas where no electricity is readily available. Absorption refrigeration units are further desirable for recreational vehicles because they are compact and lightweight, they have few moving parts, and operation is very quiet.

Absorption cooling units are unique in refrigeration because they have no moving parts and they are virtually noiseless. So-called “Single Pressure Continuous-Cycle Absorption Cooling Units”, such as unit 9 illustrated in FIG. 1 which is explained in detail hereinafter, typically comprise five main sections: a Boiler/Generator, a Condenser, an Evaporator section, an Absorber section, and an Absorber Vessel. The main sections are connected by steel tubing and the entire system is welded together to provide a rugged, air-tight, leak-proof seal.

For an absorption cooling unit to operate properly, certain conditions must be met. First, the apparatus must be deployed and operated in a level condition. Because there are no moving parts, an absorption cooling unit relies on gravity to move refrigerant throughout the system for the process to be continuous. Non-level operating conditions can adversely affect fluid transfer in critical circuit pathways.

Second, absorption cooling units require the correct heat input from the chosen heat source. Absorption refrigerators employ heat to vaporize the water/ammonia mixture, thereby driving the refrigeration process in a manner well known to those skilled in the art.

Third, such units must be well ventilated in order for the condenser to cool the vaporized ammonia and transform it into liquid ammonia refrigerant for use in the evaporator section, thus keeping the absorption refrigeration process “continuous.”

In a typical recreational vehicle, the absorption refrigerator unit is typically mounted in an opening in a wall. There is usually a space or cavity between the back of the absorption cooling unit and the exterior wall of the recreational vehicle (hereafter referred to as the cooling unit compartment). This compartment has a vent to let fresh air in the bottom and an exhaust vent at the top to expel heat produced by the cooling unit. The desired ventilation arrangement contemplates a lower vent, through which fresh air is drawn, and an exhaust vent located at the top of the cooling unit compartment that protrudes through the roof of the RV to let hot air exit. This conventional arrangement is desirable because hot air will naturally rise up and out the vent located in the roof, and hot air will not become stagnate in the cooling unit compartment.

Recently it has become a common practice for RV manufacturers to place the absorption refrigerator in a user-deployable “slide-out” room. When an RV is traveling, the so-called slide-outs are retracted and nested within the main body of the RV, providing a low traveling profile and decreased wind resistance. Once a camping destination is reached, for example, the slide-outs are deployed by unfastening them, and pulling them out of the retracted state to increase the effective volume of the camper unit by adding small rooms or dormers to the internal camper volume. The deployed room slides in and out of the side wall or other portion of the camper. When such a cooling unit is deployed within a slide-out, the ventilation arrangement is less desirable because it is not possible to deploy an exhaust vent on the roof of the retractable slide-out. This is because the room slides in and out of the camper or recreational vehicle and its pathway cannot be obstructed. In this type of installation, both vent openings are on the exterior side wall of the vehicle.

The placing of both vents on the side wall of the vehicle is usually less desirable because the upper exhaust vent is often lower than the condenser portion of the cooling unit. When the exhaust vent is even with or lower than the condenser assembly, several anomalies can occur, decreasing the cooling unit efficiency. An absorption cooling unit becomes less efficient when hot air collects or stagnates around the condenser section of the cooling unit. This stagnation limits the cooling unit's ability to convert vaporous ammonia to liquid. As a result, the cooling unit has to run for longer periods of time to maintain cold temperatures in the refrigerated space, which decreases the efficiency of the absorption cooling unit. In addition to being less efficient, the overall system temperatures of the cooling unit increases and can thermally stress critical cooling unit tubing, thus decreasing the useful life of the cooling unit.

Furthermore, it has become necessary for RV manufacturers and absorption refrigerator manufacturers to place exhaust fans on the cooling unit or in the cooling unit compartment to help move heated air out the upper sidewall vent. It is common for these exhaust fans to be operated by thermal switches that activate a fan when a predetermined temperature is reached in the cooling unit compartment. Once the temperature in the condenser area has decreased to a predetermined efficient temperature, the thermal switch opens the circuit, shutting off power to the exhaust fan. It has come to the attention of this inventor that no safety devise exists to determine if the exhaust fans are operational and take appropriate action if necessary.

In practice, however, it has been found by the present inventor that various problems might interfere with normal ventilation, thus increasing the temperature around the condenser to a point where the refrigeration process is no longer continuous, while concurrently leaving the heat source driving the refrigeration system on.

In some cooling units a vent tube bypasses the evaporator section. Those skilled in the art often refer to this tube as a “bypass tube”. During a normally continuous refrigeration cycle, this tube has no real purpose in the refrigeration cycle. However, as the temperature in the rectifier section and the condenser sections rise, and the cooling unit compartment overheats, less ammonia vapor is converted to liquid. Then less ammonia liquid enters the liquid ammonia tube that carries the liquid ammonia to the inlet of the evaporator. At this time the heat source in the boiler continues to drive more ammonia vapor up the rectifier and into and through the condenser, and because it cannot travel down the liquid ammonia tube, it starts to pass down the bypass tube, returning to the absorber vessel. The present inventor considers the cooling unit to now be operating improvidently, a “semi-continuous” state. Operation is not continuous because no refrigerant is entering the evaporator, and the cooling unit is no longer cooling the refrigerated space. Technically, said process is not “discontinuous” because the hot ammonia vapor is bypassing the evaporator and returning to the absorber tank through the by-pass or equalizer tube, where it is mixing with the strong ammonia water solution in the absorber tank and thus able to continue a supply of strong solution to the boiler and percolator pump.

One such anomaly that causes the ammonia cooling unit to become semi-continuous and pass hot ammonia vapor through the equalizer tube and back to the absorber tank is impaired ventilation. This can result from ventilation fan failure, or it can be caused by thermal switch failure, and in some less desirable sidewall venting arrangements no ventilation fans are present at all. It is also possible for the condenser fins to be obstructed by accumulated debris that would prevent proper airflow through condenser fins. Another cause of a semi-continuous refrigeration cycle is operating the absorption unit in extreme ambient conditions with less than desirable ventilation arrangement.

Furthermore it is well known to those skilled in the art that it is preferred to operate an absorption cooling unit in a level orientation. Because the absorption cooling relies on gravity to circulate the flow of refrigerant, and because the absorption cooling unit requires a heat source to drive the refrigeration process, non-level operation can destroy the cooling unit if the heat source is left uninterrupted. An amount of water containing a weak amount of ammonia flows through the boiler, removing heat from the heated tube. This flow of weak solution is continuous and regulates the temperature of the boiler tubing. After leaving the boiler this weak solution trickles down the absorber coil and returns to the absorber vessel. Operating an absorption cooling unit off level can cause this flow of weak solution to pool, decreasing the flow back to the boiler. A decreased flow of solution causes the boiler temperature to rise because less heat is being removed. If the heat source is not interrupted, excessive temperature can thermally stress the boiler tubing. One form of destruction is fatigue cracks along the welds in the boiler tubing that can release flammable refrigerant. Because an ignition source is near by, several fires have been associated with fatigue cracks in the boiler tubing. In another form of destruction, the inhibitor in the refrigerant solution can crystallize when subjected to excess heat. The crystallization of the inhibitor can restrict the flow of refrigerant in the pump tube. Furthermore if the inhibitor is removed from the weak solution, destruction of the interior walls of the boiler tubing can occur in the form of pitting which can weaken the tubing. This also can lead to ruptures of the tubing.

There are previous inventions that control the boiler temperature by placing a sensor on the boiler tubing to measure the temperature of the weak solution inside. This method is disclosed in U.S. Pat. No. 8,056,360. Since the sensor is deployed within the boiler housing, it is very time consuming and difficult to service the sensor apparatus. Substantial disassembly of the the boiler housing is required to access the sensor during boiler pipe service. Also, if the sensor is placed in close proximity to the flue pipe (also enclosed in the boiler housing), the high temperature of the flue pipe while the cooling unit is operating on propane can cause the sensor to fail or to trigger prematurely. This patent also illustrates positioning of its main temperature sensor 22 below the unit's weak solution line 28.

An improvement proposed herein is to locate a sensor on the rectifier portion of the cooling unit to measure a change in the vapor temperatures inside the rectifier. A sensor located above the weak solution level and outside the boiler housing, where the sensor can be accessed easily, will not be influenced by flue pipe temperature during propane operation, which is an improvement over current methods. When ammonia vapor leaves the boiler pump it carries with it some amount of steam that is condensed in the rectifier and by gravity returns to the boiler as a liquid. During off-level operation the amount vapor entering the rectifier increases, thus causing the vapor temperature in the rectifier to increase.

Previous art does not recognize a critical temperature relationship at the critical boundary between the pump tube and the boiler tube where heat is introduced to the pump tube to begin the pump action. In many absorption cooling units it is common for the boiler tube to make direct metal-to-metal contact with the pump tube near the bottom of the pump tube. The purpose of this contact point is made to deliver heat directly to the pump tube without overheating the weak solution surrounding the pump tube. It is at this critical contact point with the pump tube where an increase in vapor is produced by the pump tube when the cooling unit is operated unlevel.

In U.S. Pat. No. 7,050,888 a sensor on evaporator fins determines if the refrigeration process is continuous. It is felt that sensing evaporator fins to determine whether a refrigeration process is continuous is often inefficient, because the heat source is allowed to continue heating for a significant amount of time even after the refrigeration process stops. There is a time lag before the temperature at the fins has reached a predetermined high limit, partly because the sensor is in an insulated and sealed refrigerated location. Furthermore, if the sensor attached to the evaporator fins is covered by frost, it can give false readings of a continuous refrigeration process. In the latter case the heating unit wastefully continues to provide heat to the boiler. Since it is desirable to conserve energy, instant invention recognizes a need to turn off the heat source when the refrigeration cycle is no longer continuous. It is desired to provide an apparatus and process that determines non-continuous operation as fast as possible. This approach conserves power, reduces thermal stress on cooling unit tubing.

Other prior art includes U.S. Pat. Nos. 8,056,360, 7,050,888, 5,355,693, and 6,318,098, and prior publications US2012/0255317, US2012/0102981, and US2008/0178631.

### SUMMARY OF THE INVENTION

This invention provides an improved absorption refrigeration unit, an improved protective controller for absorption cooling unit, and a method for thermally sensing and controlling absorption refrigeration units. The refrigeration unit comprises a boiler/generator outputting to a rectifier section, a condenser, an evaporator section, an absorber, and an absorber vessel. The system is charged with water, ammonia and hydrogen. The invention is adapted for use in recreational vehicles to prevent absorption coolers from overheating due to off level operation, or from restricted or reduced air flow over the condenser. The invention increases cooling unit efficiency by quickly determining if the observed cooling cycle is continuous.

The preferred automatic control device is in communication with thermal sensors in three critical zones in communication with each other and in contact with the structural tubing in critical areas.

In Zone 1, the rectifier temperature is monitored. The thermal sensor in Zone 1 measures vapor temperature to determine if the unit is operating in a level condition. If the vapor temperature in zone 1 elevates to a predetermined unsafe temperature, the control unit interrupts power to the boiler. When the temperature has been reduced to a predetermined safe temperature, it can automatically close the circuit and restore power to the boiler.

In Zone 2 the condenser temperature is sensed. If the thermal switch in Zone 2 detects an unsafe rise in vapor temperature at the condenser exit it can energize suitable fans to increase condenser airflow. If the condenser temperature returns to a predetermined safe level, fan power is automatically interrupted.

However, if fan activation fails to correct the rise in condenser temperature, and hot vapor subsequently enters the evaporator bypass tube, an additional thermal sensor in zone 3 signals the controller which interrupts power to the heating unit. This occurs if the temperature of the bypass tube reaches a predetermined temperature that would indicate the refrigeration cycle is no longer continuous.

Thus a basic object of my invention is to extend the useful life of a typical absorption cooling unit by reducing thermal stress on the system.

Another basic object of my invention is to provide an improved absorption cooling unit that is highly reliable.

A further object is to provide a method and apparatus for absorption cooling units for determining if the refrigeration process is continuous as fast as possible, and for using that data to control the cooling unit.

A related basic object is to provide a method and apparatus of the character described that increases the efficiency and reliability of absorption cooling units.

Another basic object is to provide a method and apparatus for determining if absorption refrigeration processes are continuous, and for controlling the process in response to sensed data.

Stated another way, it is an object to provide an apparatus and process that determines non-continuous operation as fast as possible, thereby conserving energy, and reducing thermal stress on cooling unit apparatus and tubing.

A related object is to reduce thermal stresses on absorption cooling systems by interrupting heat sources when the sensed cooling process is not continuous.

Another related object is to guard against component breakdown and cooling unit damage by monitoring the cooling fan operation.

Another basic object is to protect absorption coolers from off- level operation by monitoring the vapor temperature in the rectifier circuit.

Yet another related object is to monitor critical temperatures within an absorption cooling unit to determine if ventilation is adequate.

It is also an object to make service easier. It is a feature of this invention that sensors normally placed within complex boiler housings can be relocated to provide easier access.

A further object is to improve the airflow over condenser fins in an absorption refrigeration unit if sensed ventilation is deemed inadequate.

These and other objects and advantages of the present invention, along with features of novelty appurtenant thereto, will appear or become apparent in the course of the following descriptive sections.

### BRIEF DESCRIPTION OF THE DRAWINGS

In the following drawings, which form a part of the specification and which are to be construed in conjunction therewith, and in which like reference numerals have been employed throughout wherever possible to indicate like parts in the various views:

FIG. 1 is a diagrammatic view of a typical prior art Continuous-Cycle Absorption Cooling Unit;

FIG. 2 is an abbreviated diagram similar to FIG. 1, but showing the location of various sensors used in the prior art;

FIG. 3 is a diagram similar to FIGS. 1 and 2, showing the sensor arrangement of the present invention;

FIG. 4 is a software flow chart of the preferred controller; and,

FIG. 5 is a graph showing temperature plots indicating a need for the present invention.

### DETAILED DESCRIPTION

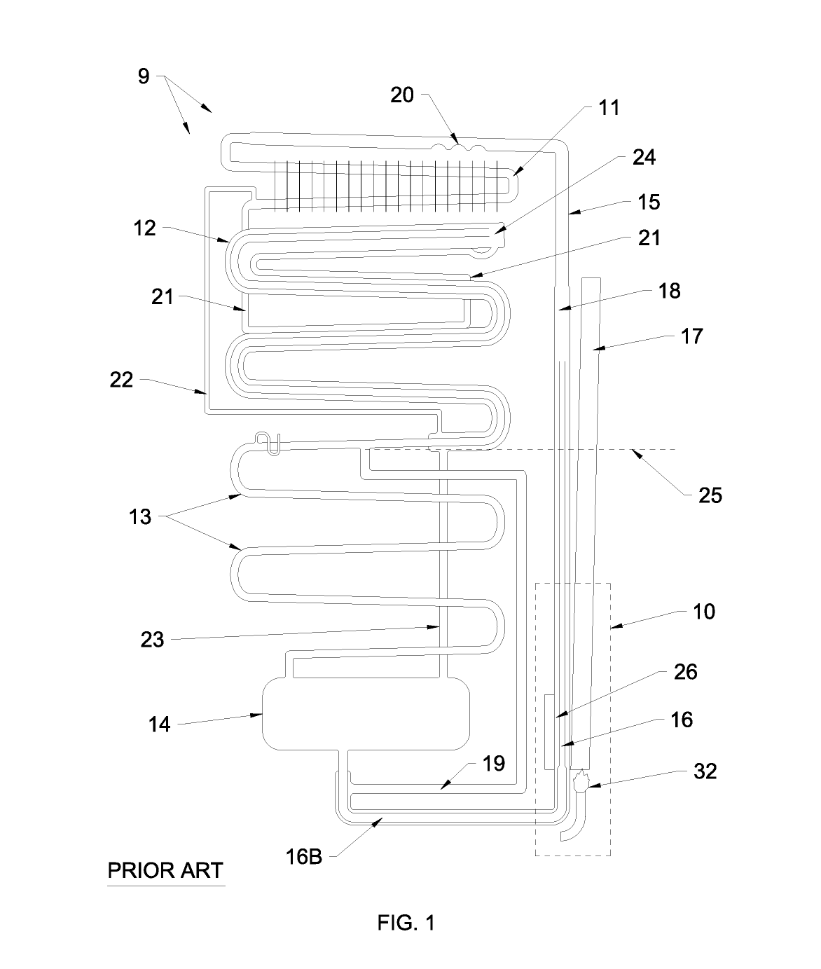

FIG. 1 shows a typical prior art cooling system 9 comprising a Boiler/Generator 10, a Condenser 11, an Evaporator section 12, an Absorber 13, and an Absorber Vessel 14. As recognized by those skilled in the art, system 9 is charged with water, ammonia and hydrogen. The combined solution is at a pressure that will allow the ammonia to condense at or near room temperature. The main sections are connected by steel tubing and the entire system is welded together to provide a rigged air-tight leak-proof seal. Subsequent parts are made up of connecting tubing. For example, the tubing that connects the boiler and condenser forms the rectifier section 15, which outputs ammonia vapor. Because the cooling unit 9 is constructed of steel, a rust inhibitor, such as sodium chromate, is typically added to the system. The rust inhibitor can be damaged when overheating of the unit occurs.

The boiler section 10 is supplied with heat to start the refrigeration process. Tubing connecting the absorber vessel 14 and the boiler section 10 comprises a pair of concentric inner and outer tubes forming a “tube within a tube” construction. As will be recognized by those with skill in the art, the inner tube 16b carries a supply of a strong ammonia/water solution to the boiler 10 where, in the boiler, the inner tube is referred to as the pump tube 16, and works similarly to a percolator tube in a coffee machine. Heat applied to the boiler section starts percolation. The annular space between pump tube 16 and outer tube 18 forms a pathway for a weak solution 26 of water with very little ammonia absorbed in it.

A conventional refrigeration process begins as heat is applied to the boiler tubing via a flue pipe 17, which causes the ammonia in the pump tube to vaporize and travel up and out the top of the pump tube into the rectifier section 15 and towards the condenser section 11. As the ammonia vapor moves up the pump tube, water that falls out the top of the pump tube and into the annular space 26 and makes up the weak solution circuit which, when full, empties into the top of the absorber coil via rising line 19; this is because gravity causes this liquid to seek a similar level within the pump tube annulus and the absorber section junction. The weak solution is water with little ammonia and it flows within the pump tubing annular space 26 then 19 to the absorber. But, as the ammonia vapor leaves the pump tube, it carries with it some water vapor that must be condensed and returned to the boilers weak solution circuit.

Obstructions 20 in the rectifier 15 are contacted by ammonia and water vapor passing through, and because the rectifier is at a lower temperature than the boiler section 10, the water vapor condenses on these obstructions and returns to the boiler by gravity. The ammonia vapor, characterized be a lower condensing temperature.,passes through the water separator line from rectifier 15 into the condenser section 11. In the condenser ammonia vapor is cooled by a series of heat exchange fins, and forms a liquid.

The tubing that makes up the condenser 11 is lined with fins that, as air passes over, extracts heat from the ammonia vapor. In the condenser, ammonia vapor temperature is lowered enough that the ammonia gas changes state (i.e., condenses) and leaves the condenser as liquid ammonia, which falls and travels downwardly by gravity to the top of the evaporator 12 via the liquid ammonia tube 21. Herein ammonia liquid and hydrogen gas meet and extract heat from the refrigerated space. In the evaporator 12, liquid ammonia trickles downwardly by gravity and settles in small grooves. Ammonia vapor that is not condensed by the time it leaves then condenser section is returned to the tank via a bypass tube 23. The evaporator is also being fed with large amounts of hydrogen gas. The hydrogen passing over the pools of ammonia allow the ammonia to evaporate at a low pressure and temperature. As the ammonia evaporates, it pulls heat from the refrigerated space as it evaporates and changes to the gas phase, cooling the refrigerated space. The vaporous ammonia mixes with the hydrogen and travels down and out of the evaporator 12 through a return tube and returns to the absorber vessel 14 through a return tube 23.

Importantly, a demarcation line 25 has been drawn in FIG. 1 to indicate the boundary between weak solution circuit and ammonia vapor circuit. The weak solutions are generally below this line; ammonia vapor circuit is above.

The ammonia/hydrogen vapor coming from the evaporator passes over the strong ammonia/water solution housed in the absorber vessel 14. Because ammonia has a strong affinity for water, enough ammonia is absorbed from the hydrogen/ammonia mixture that is light enough to start making its assent up the absorber coils 13. As the now slightly weaker hydrogen/ammonia solution travels up the absorber coils 13, it passes over a flow of weak solution that is trickling down the absorber. This weak solution absorbs more and more of the ammonia from the hydrogen/ammonia mixture, and, as it nears the top of the absorber, only pure hydrogen remains, which enters the evaporator section 12 again and travels to the top. The weak solution that entered the top of the absorber coil and trickled down becomes a strong solution again by the time it returns to the absorber tank 14. The strong solution of ammonia/water is stored in the absorber vessel and continuously feeds the boiler section 10. Bypass tubing has been designated by the reference numerals 22 (FIG. 1). In the event the air temperature surrounding the condenser is too high to change ammonia vapor from a gas to a liquid and vapor ammonia exits the condenser it can not use the liquid ammonia pathway 21 to the evaporator so it is returned to the absorber vessel via the evaporator bypass tube 22.

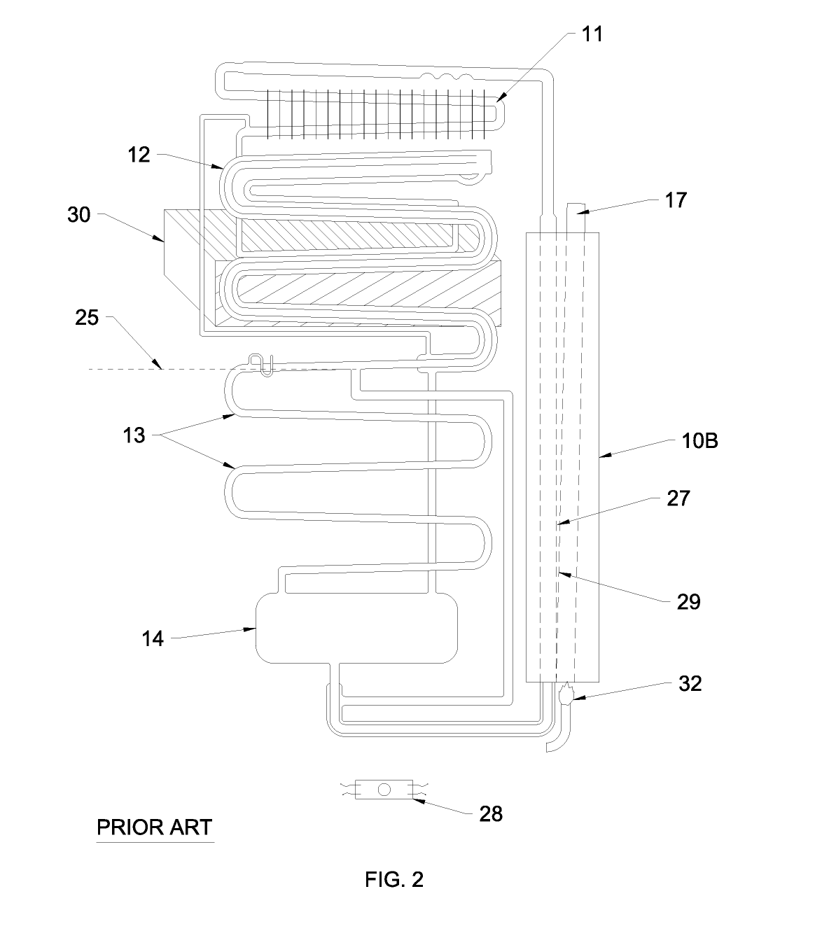

FIG. 2 illustrates prior art sensor placement with sensor locations described in U.S. Pat. No. 8,056,360. The sensor 27 is located inside the insulated boiler housing 10B in contact with the boiler tube and directly adjacent to the propane flue pipe 17, to measure the temperature of the “weak solution”. The device attempts to determine if the refrigeration process is “continuous” by using a temperature sensor in contact with the weak solution flow in the boiler section. However, the refrigeration process can cease without affecting the weak solution temperature in the boiler. A better method to determine if the refrigeration process is continuous is taught in the present invention. The present invention also teaches a better method for determining if the absorption unit is operating in a level orientation and deploys a temperature sensor in an easy to access location that is not influenced by flue temperatures in the insulated housing.

The tilt monitor associated with U.S. Pat. Pub. 2012/255,317 involves a controller to measure the position angle of the absorption refrigerator. A tilt sensor 28 (FIG. 2) is disposed in communication with the controller mounted in a housing.

In FIG. 2 a thermal sensor 29 utilized by U.S. Pat. Pub. 2012/102,981 monitors the temperature and level condition of an absorption refrigerator. The temperature sensor is associated with the generator (a/k/a Boiler) and a level sensor (such as sensor 28) may be associated with the refrigerator in communication with a controller. The present invention teaches how the refrigeration process can cease without affecting the temperature in the boiler. A better method to determine if the refrigeration process is illustrated hereinafter.

In FIG. 2 a sensor 30 of the type described in U.S. Pat. No. 7,050,888 is shown. This sensor is in contact with the evaporator fins located inside the refrigerated space. However, the refrigeration process can cease without affecting the fin temperature in the refrigerated space for extended amounts of time, during which time the cooler continues to operate. A better method to determine if the refrigeration process is continuous is taught in the present invention.

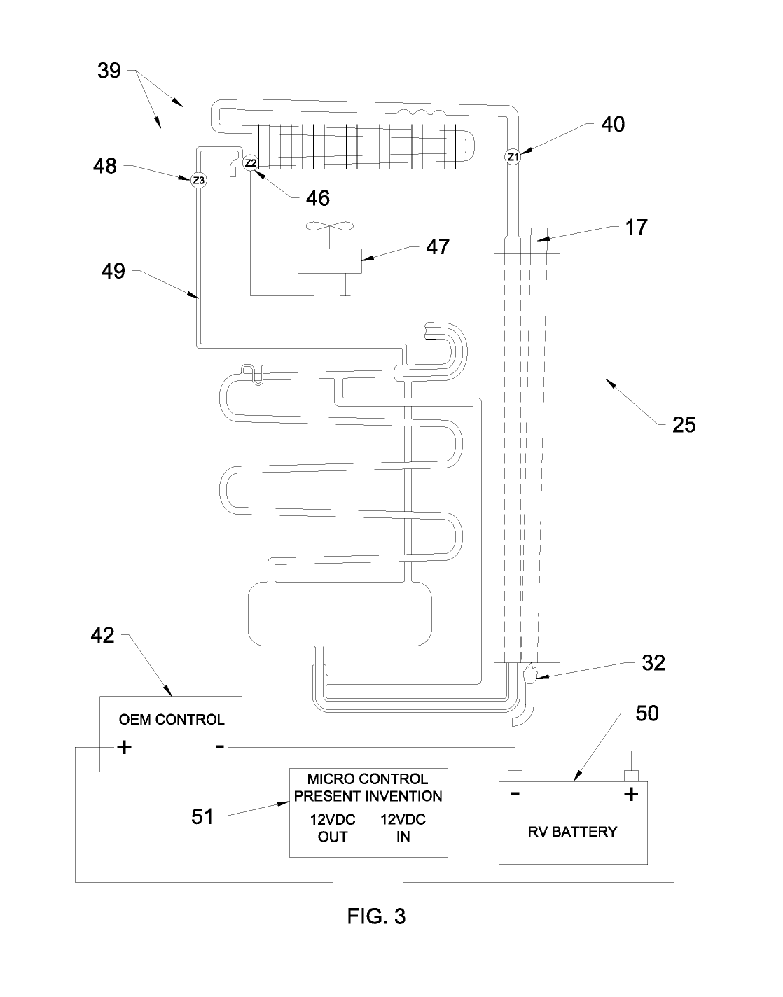

Referring to FIG. 3, the instant invention 39 senses temperatures in different locations though a different methodology. Thermal sensors of this system may include a plurality of resistance thermal detectors sensors, thermocouples, thermistors or another temperature sensing devise well known to those skilled in the art. Automatic thermal sensors in mechanical contact with unit tubing occupy zones defined as Zones 1-3. The rectifier zone is Zone 1. Condenser sensors establish Zone 2. Bypass tube sensors establish Zone 3. These sensors determine if the refrigerant cycle is continuous, has good ventilation and is operating in a level condition. All of these thermal sensors communicate electrically with the controller 51 (FIG. 3).

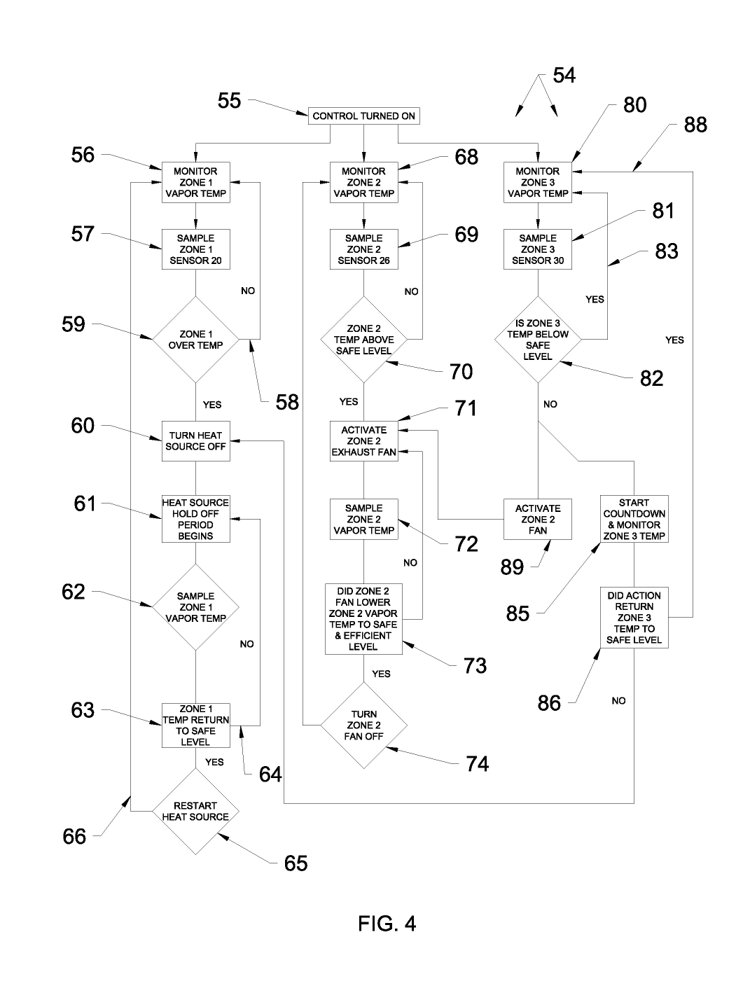

The thermal sensor in zone 1 measures vapor temperature to determine if the unit is operating in a level condition. The preferred “Zone 1” temperature sensor location for the present invention is designated by the reference numeral 40 in FIG. 3. It monitors the vapor temperature in the rectifier tube of the absorption cooling unit. Overheating of the vapor pump in the boiler section will cause excess vapor production resulting in an increase in the rectifier vapor temperature. Off level operation, poor ventilation, improper heat supply, and improper pressure in a cooling unit charge can all cause an increase in vapor production. If the Zone 1 sensor 40 (FIG. 3) in communication with controller 51 of the present invention, detects a rise in vapor temperature to a predetermined unsafe limit, controller 51 (that executes the software charted in in FIG. 4) can interrupt power to OEM refrigerator control 42 thus shutting off boiler heating unit. Once a predetermined safe limit is established, the Zone 1 sensor 40 can automatically restore power to heating unit.

In FIG. 3 the reference numeral 46 indicates the Zone 2 temperature sensor location. A sensor at Zone 2 position 46 monitors vapor temperature in the condenser. If vapor temperature increases and reaches a predetermined high safe limit due to excess ambient air temperature, or poor or restricted airflow through condenser fins, insufficient exhaust ventilation allowing hot air to stagnate, the Zone 2 sensor at position 46 will trigger an auxiliary fan 47 to move additional air through the condenser. If the temperature sensed by the Zone 2 sensor decreases to a safe predetermined lower limit, the fan 47 will be automatically interrupted.

In FIG. 3 the Zone 3 temperature sensor location for present invention is designated by the reference numeral 48. The Zone 3 sensor 48 is preferably located on the evaporator bypass tube 49. The Zone 3 sensor 48 determines if refrigerant is being supplied to evaporator, or if the temperature in zone 2 has become too high to condense the vapor refrigerant. If efforts in Zone 2 fail to lower the temperature of the ammonia to a level that will allow it to condense, then hot ammonia vapor will travel down the bypass tube bypassing the evaporator. When the temperature of the vapor in the bypass tube reaches an unsafe high limit, the Zone 3 temperature sensor, in communication with controller 51 of the present invention, can interrupt power to OEM refrigerator controller 42 thus interrupting power to the heat source driving the boiler. Once a predetermined lower limit is sensed by the Zone 3 Sensor, control 51 can reestablish power to OEM refrigerator controller 42 thus restarting boiler heating unit.

The heater or burner 32 (FIG. 3), for example, is controlled by the OEM refrigerator controller 42 which supplies power via an RV battery 50. Controller 51 of the present invention is installed in series between the OEM refrigerator controller 42 and its power source 50.

In the current drawings of this invention temperature reading were taken in zones along the vapor section of the cooling unit beginning at the top of the boiler above the weak solution section of the cooling unit. In zone 1, temperature sensors were placed along the rectifier section, sensors in zone 2 were on the exit tube of the condenser, and zone 3 sensors are on the bypass tube near the exit tube of the condenser. Also the lower absorber coil and the boiler tube. Also the air temperature was recorded in the cooling unit cabinet near the top of the condenser and a sensor was placed on the evaporator fins. Also the ambient temperature was recorded.

In FIG. 4 a flow chart 54 indicates the software-controlled steps executed by controller 51 in FIG. 3. Step 55 activates each of the three sensing zones and the three sensors detailed above.

In step 56 zone 1 monitoring commences. Step 57 initiates sampling of the zone 1 sensor. If the zone 1 temperature is normal (i.e., not excessive) the “Zone 1 over temp” step 59 returns at line 58. If zone 1 temperature is excessive, step 60 can turn off the heat source. A hold off period begins with step 61, which is followed by resampling of zone 1 temperature at step 62. If the zone 1 temperature is excessive, the holding step 61 repeats from signaling on line 64. If the temperature is not excessive, step 65 signals on line 66 to restart the boiler.

Step 55 also starts zone 2 monitoring in step 68 followed by temperature sensing in zone 2 step 69. In step 70 if excessive zone 2 temperature is sensed in step 70 then step 71 powers the auxiliary fans 47 (FIG. 3). Zone 2 vapor temperature sensing continues in step 72 and if the zone 2 temperature was lowered by the auxiliary fans, step 73 signals to turn off the fans in step 74.

Step 55 initiates zone 3 activity as well, by starting step 80, which is followed monitoring of the zone 3 temperature sensor in step 81. If below the safe level step 82 returns on lane 83. If not, step 85 can start a monitor count down, and step 86 determines if zone 3 temperature has returned to a safe level. Step 86 can turn the heat source off by repeating or initialing step 60 mentioned earlier. Otherwise return is indicated on line 88. Step 82 concurrently initiates step 89 for repeating or starting step 71 to activate auxiliary cooling fans through step 71.

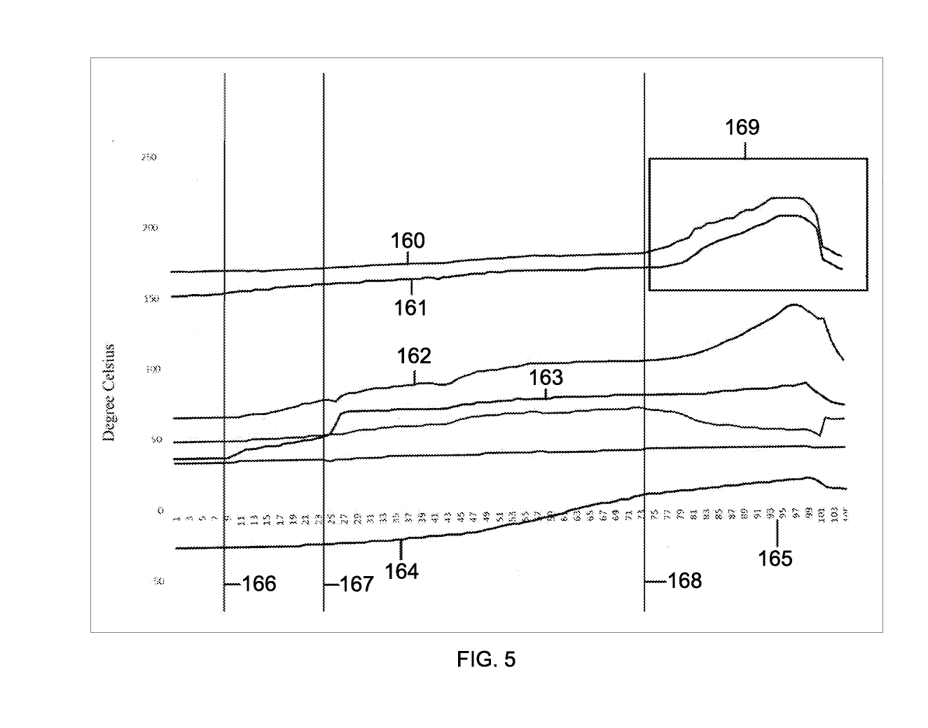

Referencing FIG. 5, the depicted graphs represent temperature data collected during a test run of an absorption cooling unit in which the cooling unit was placed in a wooden cabinet. The test cabinet was designed to simulate the installation of an absorption refrigerator in the wall of a camper. The test cabinet has a lower sidewall vent for fresh air intake and has both a roof top exhaust vent to simulate a desirable ventilation arrangement, and it has an upper sidewall exhaust vent adjacent to the condenser to simulate a less than desirable ventilation arrangement such as that in a slide out room. The test cabinet also is fitted with exhaust fans near the condenser fins that can be activated and shut off to show the effect of ventilation fan failure in a less than desirable sidewall ventilation arrangement.

The boiler weak solution temperature is represented by line 160. The vapor temperature of the rectifier is represented by line 161. Line 162 shows the vapor temperature of the upper rectifier near the entrance to the condenser. Line 163 shows the vapor temperature of the vapor bypass tube. Line 164 shows the temperature of the evaporator fins inside the refrigerated space similar to that of sensor 30 (FIG. 2).

The test begins with the rooftop vent open and the upper sidewall vent closed to simulate a desirable ventilation arrangement. At the beginning of the test the absorption cooling unit was allowed to reach a steady state temperature in all zones. Line 166 on the graph shows the point at which the rooftop vent was closed and the upper sidewall vent was opened to simulate a less than desirable ventilation arrangement such as that in a camper slide out room. Also at line 166 the exhaust fan was activated. Note that the boiler temperature line 160 has no noticeable immediate reaction to the change in the venting arrangement. Also no immediate change is noticeable in the evaporator fin sensor line 164 was recorded at this time. However there is a significant change in the vapor temperature of the zone 3 sensor indicated by line 163 on the graph. This indicated that less ammonia is being converted to liquid in the condenser which is forcing hot vapor to enter the bypass tube 22 (FIG. 1). It should be obvious to those skilled in the art that a few reasons can exist reason for the lack of response in the evaporator temperature at this time, one being frost buildup on or near the sensor located on the evaporator fins, another being a supply of cold contents in the refrigerated space. In fact it takes less than one minute to see a rise in the zone 3 bypass tube vapor temperature, while it takes over twelve minutes before the first change is noticed in the refrigerated space line 164.

Referencing line 167 on the graph (FIG. 5), at this point the ventilation fan was turned off to show the effect of ventilation fan failure in a less than desirable ventilation arrangement such as upper sidewall vent in a camper slide out room. Again an immediate response from the vapor temperature of the zone 3 bypass tube 163 and now gradual response from the temperature sensor in the refrigerated space 164. It should be noted that within just minute of ventilation fan failure the zone 3 temperature sensor represented by line 163 can determine that the refrigeration process is no longer continuous and take several actions to correct the rise noted in the zone 3 vapor bypass temperature or interrupt power to the absorption cooling units heat source if corrective measures fail to reduce the vapor bypass temperature. It is the intention of the current invention to conserve power and limit thermal stress on the cooling unit if the refrigeration process is observed to be no longer continuous. It should be obvious from the graph data that the OEM control device in U.S. Pat. No. 7,050,888 would allow the heat source continue to operate for several hours though the refrigeration process is no longer continuous.

At line 168 on the graph the absorption cooling unit was tilted at six degrees off level. Box 169 in the graph area shows the relationship between the boiler weak solution temperature 160 and the rectifier vapor temperature 161 of zone 1. The graph data shows that being tilted off level at six degree, the boiler temperature can reach critical temperatures within twenty minutes, and if left uninterrupted can cause degradation of the inhibitor as well as thermal stress on the tubing that can lead to ruptures of the pressurized tubing. Several forms of prior art teach to locate a sensor in contact with the boiler tubing weak solution circuit located inside a boiler housing. It is the novel idea of the current invention that a better method to determine if an absorption cooling unit is operating in a level condition is to deploy a temperature sensor in contact with the rectifier tube to measure the its vapor temperature. It is taught in this current invention that the vapor temperature 161 (box 169) in the rectifier 15 is directly affected by off level operation because the boiler tube is in direct contact with an internal pump/percolator and the pump tube drives ammonia vapor up to the rectifier. Because a temperature sensor located on the rectifier tube 40 (FIG. 3) is not encased by the boiler housing 10b (FIG. 2) it is easier and faster to service a temperature sensor in this location. Also a temperature sensor located on the rectifier is not influenced by flue pipe 17 temperatures while the absorption cooling unit is being operated by propane flame.

From the foregoing, it will be seen that this invention is one well adapted to obtain all the ends and objects herein set forth, together with other advantages which are inherent to the structure.

It will be understood that certain features and subcombinations are of utility and may be employed without reference to other features and subcombinations.

As many possible embodiments may be made of the invention without departing from the scope thereof, it is to be understood that all matter herein set forth or shown in the accompanying drawings is to be interpreted as illustrative and not in a limiting sense.

1. An absorption refrigeration unit comprising:
a boiler section;
a rectifier section receiving an output from said boiler section;
a condenser section forming liquid refrigerant;
an evaporator section for extracting heat when liquid refrigerant evaporates within it;
a bypass tube;
an absorber section;
a charge of water, ammonia, and hydrogen; and,
a first sensing zone comprising a first sensor for monitoring rectifier section vapor temperature to determine if the unit is operating in a level condition; and,
an automatic protective controller responsive to said first sensor in said first zone for sensing overheating from unlevel operation of the refrigeration unit, and, if and when the vapor temperature in said first zone rises to a predetermined unsafe temperature, interrupting power to the boiler; and, when the first zone temperature decreases to a predetermined safe temperature, for automatically restoring power to the boiler.

2. The absorption refrigeration unit defined in claim 1 further comprising:
a second sensing zone comprising a second sensor associated with the condenser section to monitor vapor temperature; and,
wherein, if and when sensed vapor temperature in said second zone is excessive the controller activates auxiliary fans to increase condenser airflow, and when condenser temperature returns to a predetermined safe level, the controller interrupts auxiliary fan power.

3. The absorption refrigeration unit defined in claim 2 further comprising:
a third sensing zone comprising a third sensor associated with the bypass tube for monitoring vapor temperature; and,
wherein, if and when said auxiliary fan activation fails to correct the rise in said second zone condenser temperature and hot vapor subsequently enters the evaporator bypass tube as monitored in zone 3, the controller interrupts power to the heating unit since overheating of the bypass to a predetermined temperature indicates that the refrigeration cycle is no longer continuous.

4. The absorption refrigeration unit as defined in claim 3 wherein the unit exhibits a weak solution line, and said first, second and third sensors are physically disposed above the weak solution line of the unit.

5. An automatic protective controller for single pressure absorption refrigeration units, the refrigeration units comprising a boiler section, a condenser section forming liquid refrigerant, a rectifier section establishing a vapor circuit between the boiler and the condenser, an evaporator section for extracting heat when liquid refrigerant evaporates within it, a bypass tube, an absorber section, a charge of water, ammonia, hydrogen, and rust inhibitor, and a weak solution line, the controller comprising:
a first sensor adapted to be disposed within a first sensing zone in said refrigeration unit in contact with said rectifier section for monitoring rectifier section vapor temperature; and,
said controller responsive to said first sensor for sensing overheating from unlevel operation of the refrigeration unit from rectifier section vapor temperature, and:
the controller comprises a first circuit for interrupting power to the boiler if and when the vapor temperature in said first zone rises to a predetermined unsafe temperature; and,
said controller first circuit automatically restores power to the boiler if and when the first zone temperature decreases to a predetermined safe temperature.

6. The controller as defined in claim 5 further comprising:
a second sensor adapted to be disposed within a second sensing zone in said refrigeration unit associated with the condenser section to monitor vapor temperature and sense overheating from improper or inadequate ventilation or extreme high ambient conditions;
said controller comprises a second circuit responsive to said second sensor to activate auxiliary fans to increase condenser airflow if and when sensed vapor temperature in said second zone is excessive, and, when condenser temperature returns to a predetermined safe level, the controller second circuit interrupts auxiliary fan power.

7. The controller as defined in claim 6 further comprising:
a third sensor adapted to be disposed within a third sensing zone in said refrigeration unit associated with the bypass tube for monitoring temperature; and,
said controller comprises a third circuit wherein, if and when said auxiliary fan activation caused by said second circuit fails to correct the rise in said second zone condenser temperature and hot vapor subsequently enters the evaporator bypass tube as monitored in zone 3, the controller third interrupts power to the heating.

8. The controller as defined in claim 7 wherein said first, second and third sensors are physically disposed above the weak solution line of the refrigeration unit.

9. The controller as defined in claim 5 wherein the Zone 1 temperature sensors are located above the level of the weak solution line.

10. The controller as defined in claim 5 wherein the Zone 1 temperature sensor is located away from and not influenced by heat from the boiler housing.

11. A method for controlling a single pressure absorption refrigeration unit of the type comprising a boiler section, a condenser section forming liquid refrigerant, a rectifier section establishing a vapor circuit between the boiler and the condenser, an evaporator section for extracting heat when liquid refrigerant evaporates within it, a bypass tube, an absorber section, a charge of water, ammonia, hydrogen, and rust inhibitor, and a weak solution line, the method comprising the steps of:
establishing a first sensing zone associated with said rectifier section;
monitoring vapor temperature within said first sensing zone to determine if the refrigeration unit is operating in a level condition;
if and when the vapor temperature in said first zone rises to a predetermined unsafe temperature, interrupting power to the boiler; and,
if and when the first zone temperature decreases to a predetermined safe temperature, automatically restoring power to the boiler.

12. The method as defined in claim 11 including the step of establishing said first sensing zone above said weak solution line.

13. The method as defined in claim 11 comprising the further steps of :
establishing a second sensing zone associated with the condenser section ;
monitoring vapor temperature in said second zone;
if and when sensed vapor temperature in said second zone is excessive, activating auxiliary fans to increase condenser airflow; and, if and when condenser temperature returns to a predetermined safe level interrupting auxiliary fan power.

14. The method as defined in claim 13 including the step of establishing said second sensing zone above said weak solution line.

15. The method as defined in claim 13 comprising the further steps of :
establishing a third sensing zone associated with the bypass tube for monitoring vapor temperature;
monitoring vapor temperature in said third zone to determine if the refrigeration cycle is continuous; and,
if and when said auxiliary fan activation fails to correct the rise in said second zone temperature monitored in zone 2, interrupting power to the refrigeration heating unit.

16. The method as defined in claim 15 including the step of establishing said third sensing zone above said weak solution line.
